(19) United States
(12) Patent Application Publication
(10) Pub. No.: US 2023/0009837 A1
(43) Pub. Date: Jan. 12, 2023

(54) PULLING TYPE MOVEMENT STRUCTURE, AND TOY AND MASSAGER USING SAME

(71) Applicant: Shenzhen Yisheng Technology Development Co., Ltd., Shenzhen (CN)

(72) Inventor: Hao Wang, Shenzhen (CN)

(73) Assignee: Shenzhen Yisheng Technology Development Co., Ltd., Shenzhen, GD (CN)

(21) Appl. No.: 17/948,276

(22) Filed: Sep. 20, 2022

(51) Int. Cl. A61H 19/00; A61H 23/02

(52) U.S. Cl. CPC A61H 19/44; A61H 23/0254; A61H 2201/0157

(57) ABSTRACT

The present disclosure discloses a pulling type movement structure, and a toy and a massager using the same. The pulling type movement structure includes a shell, a motor, a cam, a battery, a control circuit board, and a vibration head; the motor, the cam, the battery, and the control circuit board are respectively arranged inside the shell; the cam is arranged on an output component of the motor; a position, corresponding to a vibration head insertion opening, on the shell is provided with a rotating shaft; an extending end of the vibration head is inserted into the shell from the vibration head insertion opening of the shell, and a pulling slot is formed in an end part of the extending end of the vibration head; the rotating shaft of the shell is inserted into a rotating shaft hole of the vibration head.

### TECHNICAL FIELD

The present disclosure relates to the technical field of electric products, more specifically, to a pulling type movement structure, and a toy and a massager using the same.

### BACKGROUND

At present, a movement structure of an electric product such as a toy and a massager on the market generally only has a vibration function, which has a monotonous function and is less interesting.

### SUMMARY

The present disclosure aims to overcome the above defects in the prior art and provide a pulling type movement structure, and a toy and a massager using the same.

In order to achieve the above purpose, a first aspect of the present disclosure provides a pulling type movement structure, including a shell, a motor, a cam, a battery, a control circuit board, and a vibration head, wherein the motor, the cam, the battery, and the control circuit board are respectively arranged inside the shell; the motor and the battery are respectively electrically connected to the control circuit board; the cam is arranged on an output component of the motor; a vibration head insertion opening is formed in one end of the shell; a position, corresponding to the vibration head insertion opening, on the shell is provided with a rotating shaft; a rotating shaft hole runs through a side edge of the vibration head; an extending end of the vibration head is inserted into the shell from the vibration head insertion opening of the shell, and a pulling slot is formed in an end part of the extending end of the vibration head; the rotating shaft of the shell is inserted into the rotating shaft hole of the vibration head, so that the vibration head is rotatably mounted at one end of the shell; a pulling pillar inserted into the pulling slot is arranged on the cam; and the motor can drive the pulling pillar on the cam to rotate, so that the pulling pillar drives the vibration head to be pulled back and forth around the rotating shaft on the shell.

As a preferable implementation, the motor is a planetary motor.

As a preferable implementation, a vibration assembly is arranged inside the vibration head; the vibration assembly includes a motor and an eccentric block; and the eccentric block is arranged on an output shaft of the motor.

As a preferable implementation, a limiting pillar used for limiting a rotating range of the extending end of the vibration head is arranged inside the shell.

As a preferable implementation, an ON/OFF button is arranged on the control circuit board.

As a preferable implementation, a charging jack is arranged on the control circuit board.

As a preferable implementation, a wireless receiver is arranged on the control circuit board.

A second aspect of the present disclosure provides a toy, including a toy housing, and the pulling type movement structure according to the above technical solution is arranged inside the toy housing.

A third aspect of the present disclosure provides a massager, including a massager housing, and the pulling type movement structure according to the above technical solution is arranged inside the massager housing.

Compared with the prior art, the present disclosure has the beneficial effects below:

The motor of the pulling type movement structure can drive the pulling pillar on the cam to rotate, so that the pulling pillar drives the vibration head to be pulled back and forth around the rotating shaft on the shell, thus enriching product functions, and increasing the interestingness. The pulling type movement structure is simple in structure and is convenient to operate.

### BRIEF DESCRIPTION OF THE DRAWINGS

To describe the embodiments of the present disclosure or the technical solutions in the prior art more clearly, drawings required to be used in the embodiments or the illustration of the existing art will be briefly introduced below. Obviously, the drawings in the illustration below are some embodiments of the present disclosure. Those ordinarily skilled in the art also can acquire other drawings according to the provided drawings without doing creative work.

FIG. 1 is a schematic structural diagram of a pulling type movement structure provided according to the present disclosure;

FIG. 2 is an assembling diagram of a vibration head, a motor, and a cam provided according to the present disclosure; and

FIG. 3 is a schematic structural diagram of a shell provided in the present disclosure.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described are part of the embodiments of the present disclosure, not all the embodiments. Based on the embodiments in the present disclosure, all other embodiments obtained by those of ordinary skill in the art without creative work shall fall within the protection scope of the present disclosure.

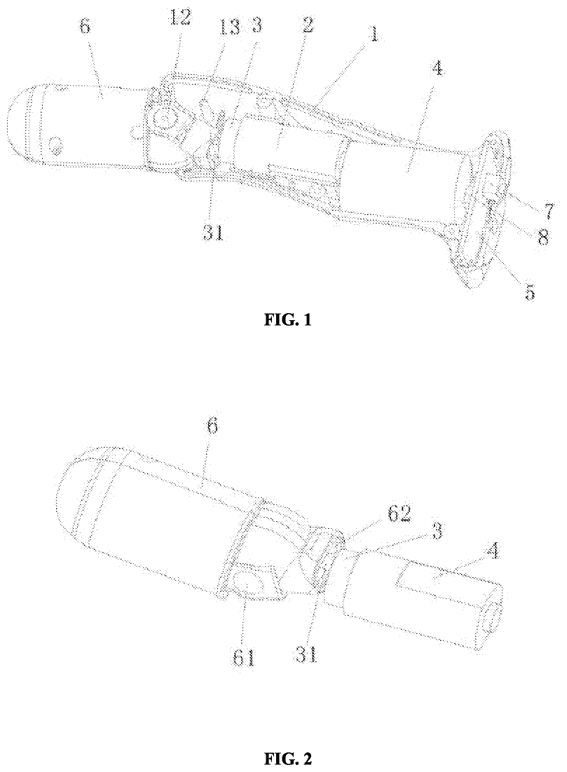

Referring to FIG. 1, an embodiment of the present disclosure provides a pulling type movement structure, including a shell 1, a motor 2, a cam 3, a battery 4, a control circuit board 5, and a vibration head 6. This embodiment will be described in detail below in combination with the accompanying drawings.

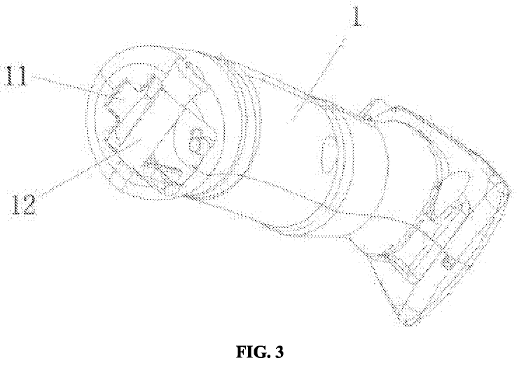

As shown in FIG. 1, FIG. 2, and FIG. 3, the motor 2, the cam 3, the battery 4, and the control circuit board 5 are respectively arranged inside the shell 1; the motor 2 and the battery 4 are respectively electrically connected to the control circuit board 5; the cam 3 is arranged on an output component of the motor 2; a vibration head insertion opening 11 is formed in one end of the shell 1; a position, corresponding to the vibration head insertion opening 11, on the shell 1 is provided with a rotating shaft 12; a rotating shaft hole 61 runs through a side edge of the vibration head 6; an extending end of the vibration head 6 is inserted into the shell 1 from the vibration head insertion opening 11 of the shell 1, and a pulling slot 62 is formed in an end part of the extending end of the vibration head; the rotating shaft 12 of the shell 1 is inserted into the rotating shaft hole 61 of the vibration head 6, so that the vibration head 6 is rotatably mounted at one end of the shell 1; a pulling pillar 31 inserted into the pulling slot 62 is arranged on the cam 3; and the motor 2 can drive the pulling pillar 31 on the cam 3 to rotate, so that the pulling pillar 31 drives the vibration head 6 to be pulled back and forth around the rotating shaft 12 on the shell 1.

In this embodiment, the motor 2 may be preferably a planetary motor.

In this embodiment, a vibration assembly is arranged inside the vibration head 6; the vibration assembly includes a motor and an eccentric block; and the eccentric block is arranged on an output shaft of the motor. The motor can drive the eccentric block to rotate, so that the vibration head 6 vibrates.

Preferably, a limiting pillar 13 used for limiting a rotating range of the extending end of the vibration head 6 can be arranged inside the shell 1.

An ON/OFF button 7 and a charging jack 8 are arranged on the control circuit board 5. The battery 4 can be charged through the charging jack 8. Of course, in other embodiments, other buttons may also be arranged on the control circuit board 5.

In order to add a wireless control function to the product, a wireless receiver is arranged on the control circuit board 5. During specific operation, a wireless signal can be sent by a wireless control box to control the product to be pulled and vibrate.

It should be noted here that the pulling type movement structure can be applied to a toy. The pulling type movement structure is arranged inside a toy housing. Of course, the pulling type movement structure can also be applied to a massager. The pulling type movement structure is arranged inside a massager housing.

To sum up, the motor of the pulling type movement structure can drive the pulling pillar on the cam to rotate, so that the pulling pillar drives the vibration head to be pulled back and forth around the rotating shaft on the shell, thus enriching product functions, and increasing the interestingness. The pulling type movement structure is simple in structure and is convenient to operate. The massage comfort level of the product can be also improved if the pulling type movement structure is applied to the massager.

The above-mentioned embodiments are preferred implementation modes of the present disclosure, but the implementation modes of the present disclosure are not limited by the above-mentioned embodiments, and any other changes, modifications, substitutions, combinations, and simplifications that are made without departing from the spirit and principle of the present disclosure shall all be equivalent replacement methods, which all fall within the protection scope of the present disclosure.

What is claimed is:

1. A pulling type movement structure, comprising a shell, a motor, a cam, a battery, a control circuit board, and a vibration head, wherein the motor, the cam, the battery, and the control circuit board are respectively arranged inside the shell; the motor and the battery are respectively electrically connected to the control circuit board; the cam is arranged on an output component of the motor; a vibration head insertion opening is formed in one end of the shell; a position, corresponding to the vibration head insertion opening, on the shell is provided with a rotating shaft; a rotating shaft hole runs through a side edge of the vibration head; an extending end of the vibration head is inserted into the shell from the vibration head insertion opening of the shell, and a pulling slot is formed in an end part of the extending end of the vibration head; the rotating shaft of the shell is inserted into the rotating shaft hole of the vibration head, so that the vibration head is rotatably mounted at one end of the shell; a pulling pillar inserted into the pulling slot is arranged on the cam; and the motor can drive the pulling pillar on the cam to rotate, so that the pulling pillar drives the vibration head to be pulled back and forth around the rotating shaft on the shell.

2. The pulling type movement structure according to claim 1, wherein the motor is a planetary motor.

3. The pulling type movement structure according to claim 1, wherein a vibration assembly is arranged inside the vibration head; the vibration assembly comprises a motor and an eccentric block; and the eccentric block is arranged on an output shaft of the motor.

4. The pulling type movement structure according to claim 1, wherein a limiting pillar used for limiting a rotating range of the extending end of the vibration head is arranged inside the shell.

5. The pulling type movement structure according to claim 1, wherein an ON/OFF button is arranged on the control circuit board.

6. The pulling type movement structure according to claim 1, wherein a charging jack is arranged on the control circuit board.

7. The pulling type movement structure according to claim 1, wherein a wireless receiver is arranged on the control circuit board.

8. A toy, comprising a toy housing, wherein the pulling type movement structure according to claim 1 is arranged inside the toy housing.

9. A massager, comprising a massager housing, wherein the pulling type movement structure according to claim 1 is arranged inside the massager housing.
